(19) United States
(12) Patent Application Publication
(10) Pub. No.: US 2007/0082526 A1
(43) Pub. Date: Apr. 12, 2007

(54) Screwdriver Bit and Mating Socket

(76) Inventor: Bernard Tanner, Calgary, AB (CA)

Correspondence Address: ADE & COMPANY INC., 2157 Henderson Highway, WINNIPEG, MB, R2G1P9, CA

(21) Appl. No.: 11/608,917

(22) Filed: Dec. 11, 2006

Related U.S. Application Data
(63) Continuation-in-part of application No. 10/507,839, filed on Sep. 15, 2004.
(60) Provisional application No. 60/441,273, filed on Jan. 21, 2003.

(51) Int. Cl. H01R 29/00

(52) U.S. Cl. 439/188

(57) ABSTRACT

A screw driver bit includes four side walls arranged in a square cross section substantially throughout a length thereof which taper inwardly towards one another towards the apex of the bit such that the bit is arranged to mate with each of a plurality of different standard size Robertson type sockets. A corresponding socket also includes four side walls arranged in a square cross section throughout the length thereof as the side walls taper inwardly towards the apex such that the socket is arranged to mate with the corresponding bit and with each of a plurality of different standard size Robertson type screwdriver bits.

This application is a continuation-in-part of U.S. parent application Ser. No. 10/507,839, filed Sep. 15, 2004, which is a national phase filing of PCT/CA04/00065, filed Jan. 20, 2004 and claims the benefit under 35 U.S.C. 119(e) of U.S. provisional application Ser. No. 60/441,273, filed Jan. 21, 2003.

### FIELD OF THE INVENTION

The present invention relates to a bit for a screwdriver arranged for mating with existing Robertson type sockets, and a corresponding socket arranged for mating with the bit and with existing Robertson type bits.

### BACKGROUND

Screws, and other types of threaded fasteners, are commonly used as fasteners in all types of applications and accordingly several different designs of sockets and corresponding driver bits are known to be used. One of the most common socket designs is known as a Robertson socket which is generally square in cross section with opposing side walls of the socket being parallel to one another. It is common practice to make use of several different size sockets depending upon the size of the screw and accordingly several different size mating driver bits are required in order to provide effective mating engagement and prevent stripping of the socket or the driver bit in use.

### SUMMARY

According to one aspect of the present invention there is provided a screwdriver bit arranged for use with a plurality of Robertson type sockets different in size from one another, the bit comprising:

a mounting portion arranged to be supported on a driver; and

a mating portion extending in a longitudinal direction from the mounting portion at an inner end to an apex at an opposing free end;

the mating portion comprising four side walls having identical dimensions and being arranged such that the mating portion has a square cross section substantially throughout a length of the mating portion in the longitudinal direction between the inner end and the apex; and

the side walls tapering inwardly towards one another from the inner end to the apex such that the mating portion is arranged to mate with each of the plurality of Robertson type sockets different in size from one another.

Preferably the side walls taper inwardly such that the mating portion is arranged to mate with the plurality of Robertson type sockets different in size from one another at respective mating positions spaced longitudinally from one another.

In one embodiment, the side walls are continuous in profile such that the mating portion has a gradually decreasing cross sectional dimension between the respective mating positions. In this instance, the side walls are preferably convex.

In a second embodiment, the side walls are stepped in profile such that a shoulder is formed at each of the mating positions. In this instance, the mating portion preferably includes a longitudinally extending portion of constant cross sectional dimension at each mating position.

In either embodiment, the apex preferably comprises a flat square end face lying perpendicular to the longitudinal direction.

The mating portion may define 2 or 3 mating positions, but preferably 4 different mating positions therealong, in which each mating position is arranged to mate with a respective size Robertson type socket different in size from the other mating positions.

According to a second aspect of the present invention there is provided a fastener socket arranged for use with a plurality of Robertson type screwdriver bits different in size from one another, the socket comprising:

four side walls having identical dimensions and being arranged such that the walls have a square cross section substantially throughout a length thereof between an inner bottom end and an outer free end of the socket;

the side walls tapering inwardly towards one another from the outer free end to the inner bottom end such that the side walls are arranged to mate with each of the plurality of Robertson type screwdriver bits different in size from one another at respective mating positions along the side walls.

In one embodiment, the side walls of the socket are also continuous in profile such that the socket has a gradually decreasing cross sectional dimension from the outer free end to the inner bottom end. The side walls in this instance are preferably concave for mating with the convex side walls of the corresponding bit described herein.

In another embodiment, the side walls of the socket are also stepped in profile defining a shoulder at each of the mounting positions. In this instance, there may be provided a longitudinally extending portion of constant cross sectional dimension at each mating position along the side walls of the socket.

The use of convex or stepped walls on a driver bit of square cross section permits a single driver bit configuration to mate with many sizes of sockets of existing Robertson design. Similarly the use of concave or stepped walls defining the socket of a threaded fastener permits various sizes of conventional Robertson driver bits to be snugly and matingly engaged within a given socket size. The combination of mating socket and bit walls permits one driver bit to be used with different size sockets within the same set while making a perfect mating engagement therebetween in each instance.

In either configuration of the bit and socket, the socket and the corresponding bit include an equal number of side walls for mating with one another. In alternate configurations, the particular number of side walls of both the bit and socket may be varied from 3 to 4, 5 or more sides as desired while still maintaining the benefits of mating convex and concave or stepped surfaces of the bit and socket respectively.

### BRIEF DESCRIPTION OF THE DRAWINGS

In the accompanying drawings, which illustrate exemplary embodiments of the present invention:

FIG. 1 is a side elevational view of a first embodiment of the bit.

FIG. 2 is an end view of the bit according to FIG. 1.

FIG. 3 is a sectional view along the line 3-3 of FIG. 1.

FIG. 4 and FIG. 5 are partly sectional elevational views of the bit according to FIG. 1 mated with two different sizes of Robertson sockets.

FIG. 6 is a partly sectional elevational view of the bit according to FIG. 1 mated with a corresponding socket.

FIG. 7 and FIG. 8 are partly sectional elevational views of the socket according to FIG. 6 shown mated with two different sizes of Robertson bits.

FIG. 9 is a side elevational view of a second embodiment of the bit.

FIG. 10 is an end view of the bit according to FIG. 9.

FIG. 11 is a sectional view along the line 11-11 of FIG. 9.

FIG. 12 and FIG. 13 are partly sectional elevational views of the bit according to FIG. 9 shown mated with two different sizes of Robertson sockets.

FIG. 14 is a partly sectional view of the bit according to FIG. 9 shown mated with a corresponding socket.

FIG. 15 and 16 are partly sectional elevational views of the socket according to FIG. 14 shown mated with two different sizes of Robertson bits.

FIG. 17 and FIG. 18 are partly sectional elevational views of sockets arranged to mate with the bit of FIG. 9, but which are reduced in depth for use in smaller fasteners.

In the drawings like characters of reference indicate corresponding parts in the different figures.

### DETAILED DESCRIPTION

Referring to the accompanying drawings, there is illustrated a bit generally indicted by reference numeral 10 which is particularly suited for being supported on a screwdriver and the like for engaging a corresponding socket 12 to drive rotation thereof. Both the bit and the socket are arranged such that each is arranged to mate with several different sizes of conventional, standard size and commercial available Robertson sockets 14 and bits 16 respectively.

The bit 10 generally comprises an elongate body having a mounting portion 20 suitable for mounting within the chuck of a rotary driving tool or for being formed integrally with the shaft of a screwdriver. A mating portion 22 extends from the mounting portion, formed integrally therewith at an inner end 24 to extend in the longitudinal direction from the mounting portion to an opposing outer free end 26 defining an apex 28 at the lateral center of the bit.

The mating portion 22 includes four side walls 30 which are identical in dimension and configuration relative to one another and are arranged in two opposed pairs in a rectangular configuration so that each of the side walls 30 faces radially outwardly from the center of the bit. The side walls 30 are configured relative to one another so that the mating portion 22 has a square cross section lying perpendicular to the longitudinal direction throughout the full length of the mating portion 22 in the longitudinal direction between the inner end 24 and the outer free end 26. The side walls 30 terminate at respective sides of the apex which comprises a blunt end face having a square contour and being flat so as to lie perpendicular to the longitudinal direction of the bit.

The side walls 30 are arranged to taper inwardly from the inner end 24 of the mating portion at the mounting portion 20 towards the apex 28 at the outer free end 26. The tapering cross sectional dimension between the side walls 30 intersects four different standard sizes of conventional Robertson sockets between the inner and outer ends of the mating portion. Thus at least a portion of the mating portion 22 has a cross sectional dimension which mates with each of the standard sizes of Robertson sockets including number 0, 1, 2 and 3. At the intersection of the mating portion 22 with each of the standard sizes of Robertson sockets, the side walls 30 define a mating position at which the dimensions of a respective one of the Robertson sockets is matched. These mating positions are longitudinally spaced from one another and are arranged such that the smallest cross sectional dimension of the mating positions is located at the apex, whereas the largest cross sectional dimension mating position is located adjacent the inner end 24 of the mating portion.

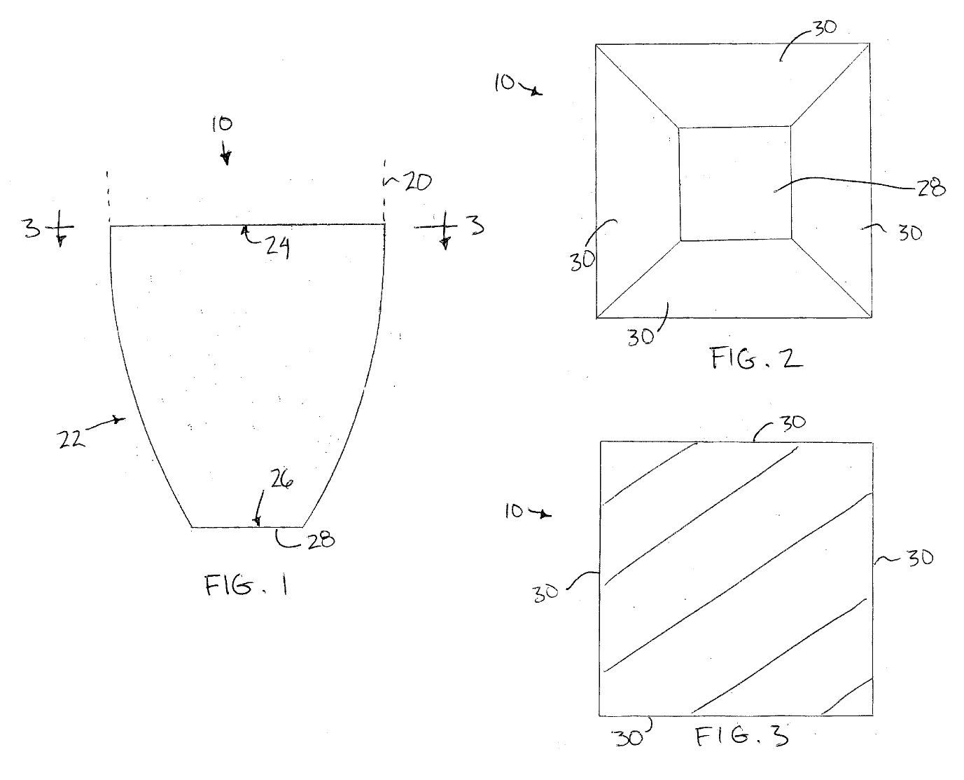

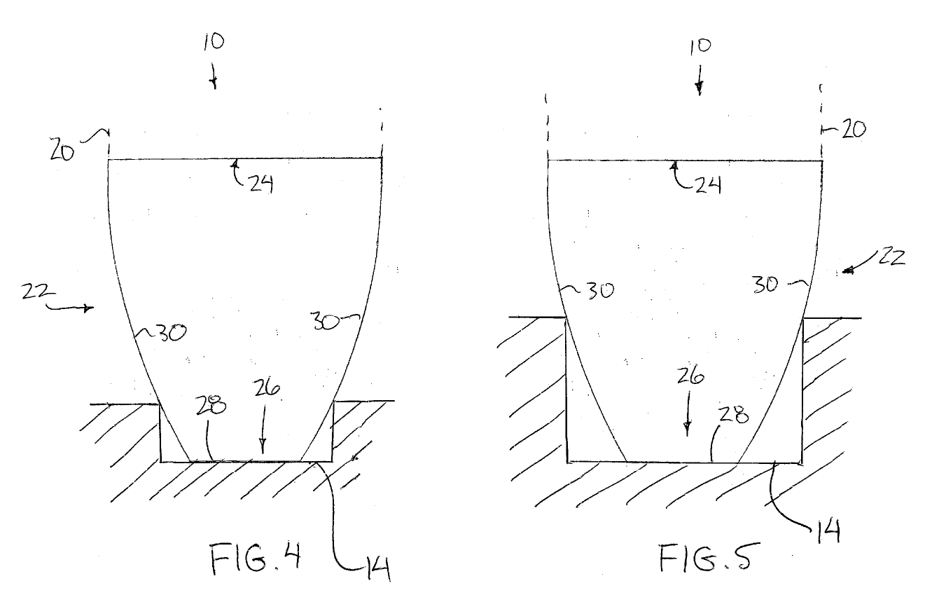

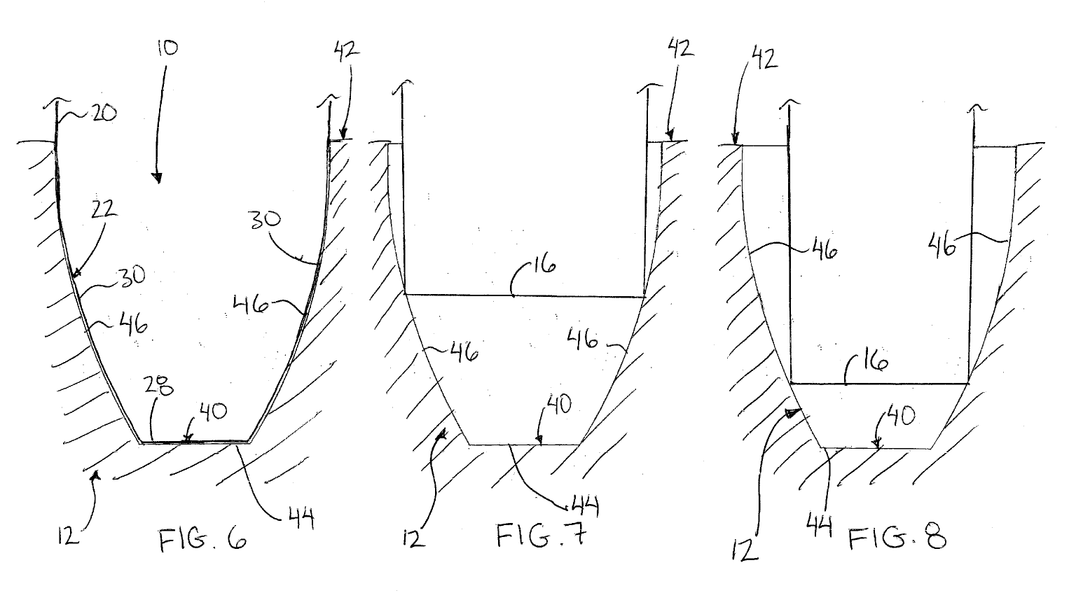

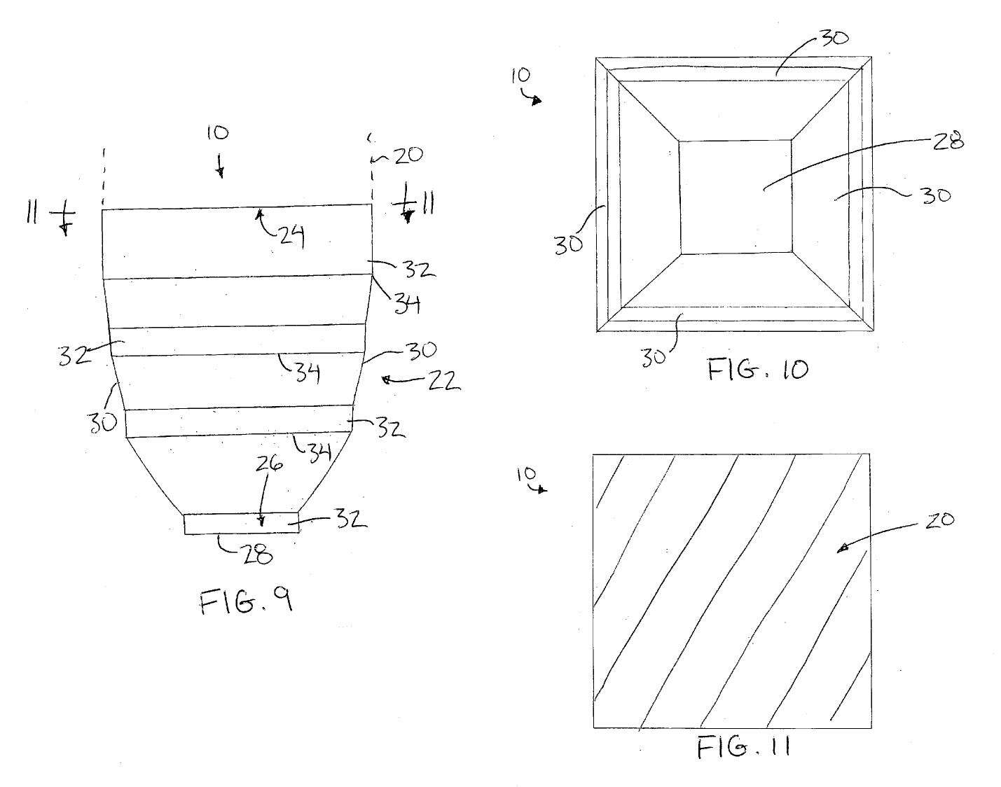

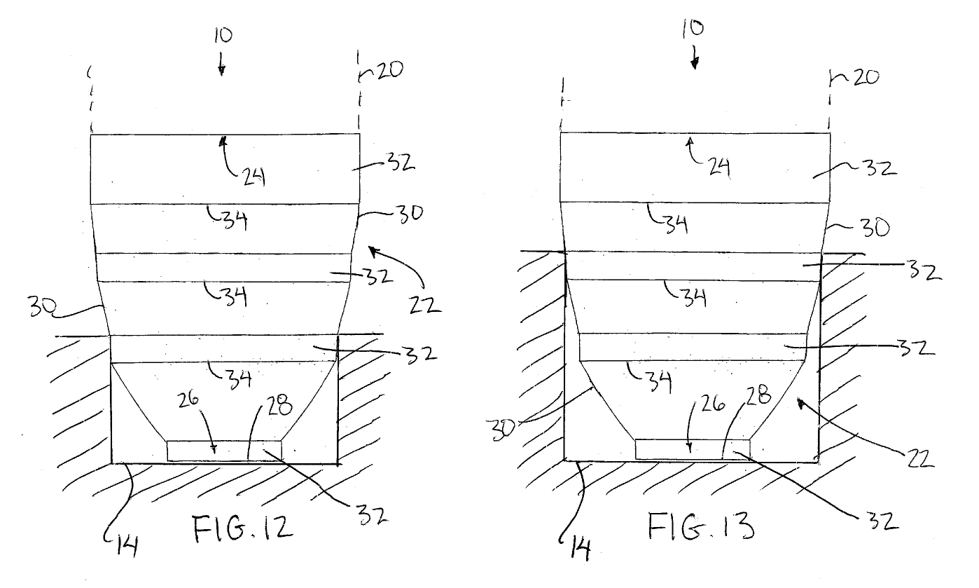

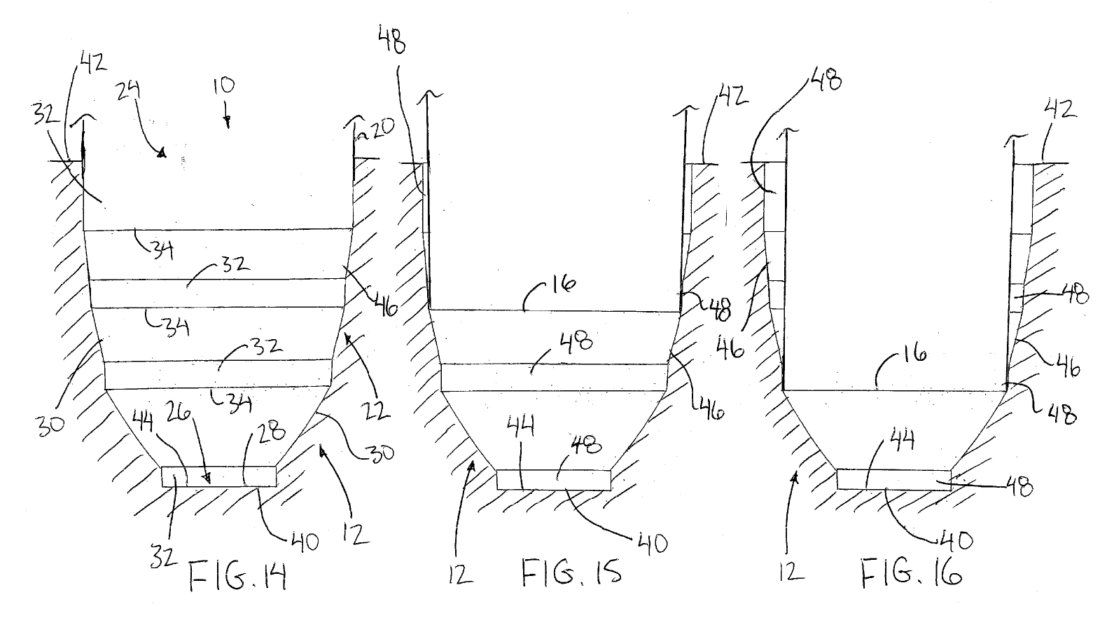

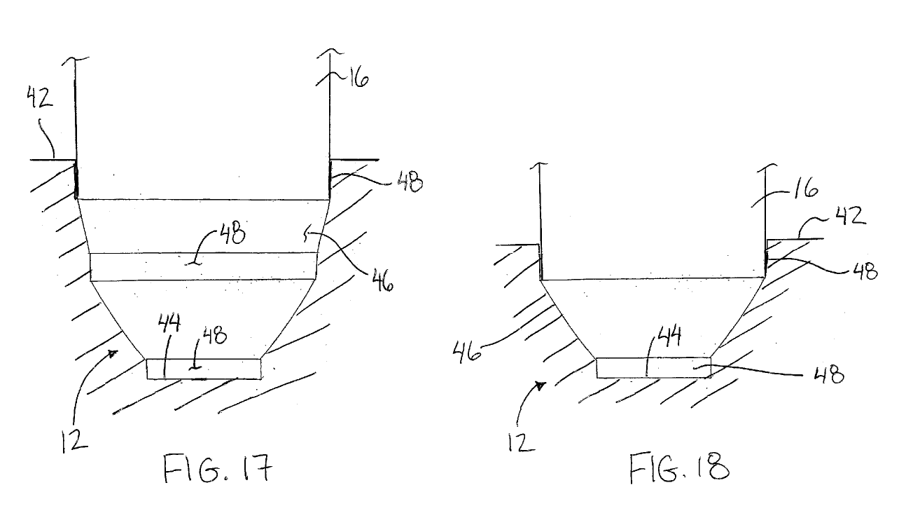

Turning now more particularly to the embodiment of FIGS. 1 through 6, the side walls 30 are shown to be smooth and continuous in profile between the inner end and the outer free end of the mating portion of the bit. The side walls relative to one another thus define a gradually decreasing cross sectional dimension therebetween to define convex shaped side walls as seen in profile. The curvature of the side walls is arranged to be sufficient that when any one of the mating positions along the side walls are mated with the corresponding standard size Robertson socket within which it fits, distance from that mating position to the apex is sufficiently small that the apex will not bottom out within the socket and prevent proper engagement of the mating position of the bit form engaging the periphery of the socket. The convex side walls thus has a sufficiently steep curved surface which is inclined relative to the longitudinal direction enough to ensure that distance between the apex and each mating position is shorter than the distance in the corresponding standard size Robertson socket between its inner bottom end and its outer peripheral edge.

Referring now to FIGS. 9 through 14, the side walls 30 in this instance are stepped in profile forming separate tiers 32 at each of the mating positions along the mating portion 22 of the bit. The tier 32 at each mating position comprises a longitudinally extending portion of the bit of constant cross sectional dimension. The cross sectional dimension between each adjacent pair of tiers 32 is reduced by the side walls extending inwardly towards one another as they approach the apex between the tiers. The transitional area between each adjacent pair of tiers 32 thus defines a shoulder 34 at longitudinally spaced positions along the length of the side walls from the other shoulders 34.

The smallest tier 32 is located adjacent the apex while the largest tier 32 is located at the inner end 24 of the bit to be formed integrally with the mounting portion 20. The tiers 32 defining a longitudinally extending portion of constant cross sectional dimension have approximately the same length as one another in the longitudinal direction and may be near in length to the transitional areas between adjacent tiers 32 where the side walls are inclined inwardly towards one another. The transitional areas also extend in the longitudinal direction corresponding lengths which are substantially similar to one another.

The inclination at the transition areas is sharp enough and inclined steep enough relative to the longitudinal direction that the distance from each mating position defined at one of the tiers to the apex is smaller than the longitudinal distance between the inner bottom end and the outer periphery edge of a corresponding one of the conventional Robertson sockets which is mated with that particular mating position or tier 32. In this arrangement the bit according to FIG. 9 is substantially identical to the bit according to FIG. 1.

As described herein the bits of FIG. 1 and FIG. 9 are suitably arranged for mating with different sizes of conventional Robertson sockets. As shown in FIGS. 4 and 5, as well as in FIGS. 12 and 13, by mating a different one of the mating positions of the side walls with the outer peripheral edge of the conventional Robertson socket the bit is penetrated also to different depths within the socket corresponding to the longitudinal positioning of the mating position along the side walls.

In addition to mating with existing sockets, the bits described herein are also particularly useful for mating with the corresponding mating sockets 12 which mate therewith along a full length of the socket at each of the plural longitudinally spaced mating positions therealong. Sockets of this character and as illustrated in FIGS. 6 through 8 and FIGS. 14 through 16 are also arranged for mating with a plurality of different sizes of existing Robertson bits of standard size. The common features of the two different embodiments of the socket 12 will now be described in further detail.

The socket 12 extends generally in a longitudinal direction from an inner bottom end 40 to an outer free end 42 defining an outer peripheral edge of the socket. An apex 44 is formed at the inner bottom end which is square in contour forming a flat blunt end face which lies generally perpendicular to the longitudinal direction. Four side walls 46 span from the square peripheral edge at the outer free end 42 of the socket to respective sides of the square apex 44 at the inner bottom end. The apex 44 has a smaller cross sectional dimension than the square peripheral edge at the outer free end 42 so that the side walls 46 taper inwardly towards one another from the outer free end 44 to the inner bottom end 40.

The side walls 46 are configured relative to one another so that the socket maintains a square cross sectional shape throughout the length thereof along the longitudinal direction from the outer free end to the inner bottom end. The inwardly tapering dimension of the socket intersects four different sizes of Robertson bits, that is standard sizes 0, 1, 2 and 3. As shown in FIGS. 7 and 15, a first standard size Robertson bit is penetrated to only overlap less than half the depth of the socket for snug engagement at a respective mating position along the side walls. A second, smaller size of Robertson bit as shown in FIGS. 8 and 16, however is penetrated further into the socket for mating at a respective second mating position of the side walls where a different size of Robertson bit is again snugly mated within the cross sectional dimension of the socket.

Similarly to the bits described above, a mating position is accordingly defined at each point in the side walls of the socket where the cross sectional dimension therebetween corresponds with a standard size of Robertson bit. Also similar to the bits noted above, the smallest cross sectional dimension is located at the apex whereas the largest cross sectional dimension is located at the outer peripheral edge of the socket.

Turning now more particularly to the embodiment of the socket shown in FIGS. 7 and 8, the side walls have a smooth continuous profile with a gradually decreasing cross sectional dimension between the opposing sides so as to define concave walls of a curvature which mates perfectly with the curvature of the bit 1 0 as described in FIGS. 1 through 6. The socket in this instance is sufficiently shallow due to the sharp curvature of the concave walls relative to the longitudinal direction so that even the smallest size of Robertson bit can be penetrated into the socket and engage the corresponding mating position at the bottom of the socket without the shaft of the corresponding driver supporting the bit thereon being engaged with the peripheral edge at the outer end of the socket to ensure proper mating engagement of the bit within the socket.

Turning now to FIGS. 15 and 16, a second embodiment of the socket is illustrated in which the side walls are stepped in profile to form corresponding tiers 48 which are similar in character to the tiers 32 of the bit according to FIGS. 9 through 14 for perfect mating engagement between the socket and bit according to the second embodiment. Each of the tiers 48 thus defines a respective mating position where the socket defines a longitudinally extending portion of constant cross sectional dimension between opposed side walls with transitional areas being defined between each tier 32 or mating position defined thereby.

The tiers 48 are substantially the same length as one another in the longitudinal direction, and may be similar in length to the transitional areas between adjacent tiers which are also similar in length to one another in the longitudinal direction. The transitional areas include a slope of sufficient steepness relative to the longitudinal direction that distance from the smallest tier at the apex to the outer peripheral edge of the socket is sufficiently small that a standard size mating Robertson bit will be at least as long to allow engagement of the bit with the smallest tier at the apex of the socket without the corresponding mounting portion or shaft of the bit being engaged upon the peripheral edge at the outer end of the socket similarly to the pervious embodiment of the socket.

Turning now to FIGS. 17 and 18, two variations of the second embodiment of the socket 12 shown in FIGS. 14 through 16 are shown. The sockets in this instance include only three tiers 48 and two tiers 48 respectively. All of the features with regard to mating with different standard sizes of Robertson bits can still be realised, but only with the smaller sizes of the available bits. The overall depth or length of the socket 12 must be reduced for use in smaller fasteners as required. The socket 12 according to the first embodiment in FIGS. 6 through 8 may be reduced in depth or length similar to the sockets shown in FIGS. 17 and 18 so that the resulting socket defines mating positions corresponding only to smaller sizes of available standard size Robertson bits. Even when reducing the depth of the socket, the configuration and cross sectional dimension at the inner bottom end remains the same.

The particular configuration of the socket and the bit as described herein permit various sizes of sockets to be driven with a given driver bit size while also permitting various size driver bits to drive a given size socket.

As described herein, the socket of the present invention is typically used on a fastener of the type comprising a screw with a head supported on the end of a threaded shaft. The socket is located within the head for connection with a driver bit as in conventional screw drivers and screws. The socket includes plural inner side walls which face inwardly towards a centre of the socket to confront opposing ones of the inner side walls. In one of the illustrated embodiments, each side wall curves downwardly and inwardly from an outer end at the surface of the head to an inner end at a common apex of the socket. Each side wall in this instance thus defines a concave surface of equal size and spacing with respect to the remaining side walls of the socket.

The screwdriver bit as described above is typically supported on the end of a shaft of a screwdriver having a handle mounted on the opposing end of the shaft. The bit includes plural outer side walls which face outwardly in respective radial directions away from a central common apex of the bit. Each of the outer side walls curves downwardly and inwardly towards the common apex so as to define a convex outer surface which is suitably arranged for mating with the corresponding inner side walls of a respective socket.

In the illustrated embodiments described above, the socket is square in cross section so as to be suitably arranged for mating with conventional Robertson design driver bits. The concave side walls of the socket permit various sizes of Robertson bits to be securely engaged by bottoming out the free end of the driver bit within the inner side walls at respective mating locations. Furthermore the arrangement of the bit as illustrated can fit with various size sockets of Robertson design due to the convex surfaces of the outer side walls which ensure engagement with the Robertson socket at the surface of the head of the screw without concern of the free end at the common apex of the bit bottoming out within the socket of a Robertson screw.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A screwdriver bit arranged for use with a plurality of Robertson type sockets different in size from one another, the bit comprising:
a mounting portion arranged to be supported on a driver; and
a mating portion extending in a longitudinal direction from the mounting portion at an inner end to an apex at an opposing free end;
the mating portion comprising four side walls having identical dimensions and being arranged such that the mating portion has a square cross section substantially throughout a length of the mating portion in the longitudinal direction between the inner end and the apex; and
the side walls tapering inwardly towards one another from the inner end to the apex such that the mating portion is arranged to mate with each of the plurality of Robertson type sockets different in size from one another.

2. The bit according to claim 1 wherein the side walls taper inwardly such that the mating portion is arranged to mate with the plurality of Robertson type sockets different in size from one another at respective mating positions spaced longitudinally from one another.

3. The bit according to claim 2 wherein the side walls are continuous in profile such that the mating portion has a gradually decreasing cross sectional dimension between the respective mating positions.

4. The bit according to claim 3 wherein the side walls are convex.

5. The bit according to claim 3 in combination with a socket wherein the socket comprises four side walls having identical dimensions and arranged such that the side walls have a square cross section substantially throughout a length thereof between an inner bottom end and an outer free end of the socket, and wherein the side walls taper inwardly towards one another from the outer free end to the inner bottom end so as to be arranged to mate with the mating portion of the bit along the length of the mating portion.

6. The bit according to claim 2 wherein the side walls are stepped in profile such that a shoulder is formed at each of the mating positions.

7. The bit according to claim 6 wherein the mating portion includes a longitudinally extending portion of constant cross sectional dimension at each mating position.

8. The bit according to claim 6 in combination with a socket wherein the socket comprises four side walls having identical dimensions and arranged such that the side walls have a square cross section substantially throughout a length thereof between an inner bottom end and an outer free end of the socket, and wherein the side walls taper inwardly towards one another from the outer free end to the inner bottom end so as to be arranged to mate with the mating portion of the bit along the length of the mating portion.

9. The bit according to claim 1 wherein the mating portion defines at least three mating positions therealong which are arranged to mate with three different sizes of Robertson type sockets.

10. The bit according to claim 1 wherein the apex comprises a flat square end face lying perpendicular to the longitudinal direction.

11. A screwdriver bit in combination with a plurality of Robertson type sockets different in size from one another, the bit comprising:
a mounting portion arranged to be supported on a driver; and
a mating portion extending in a longitudinal direction from the mounting portion at an inner end to an apex at an opposing free end;
the mating portion comprising four side walls having identical dimensions and being arranged such that the mating portion has a square cross section substantially throughout a length of the mating portion in the longitudinal direction between the inner end and the apex; and
the side walls tapering inwardly towards one another from the inner end to the apex such that the mating portion is arranged to mate with each of the plurality of Robertson type sockets different in size from one another.

12. The combination according to claim 11 wherein the side walls are continuous in profile such that the mating portion has a gradually decreasing cross sectional dimension between the respective mating positions.

13. The combination according to claim 12 wherein the side walls are convex.

14. The combination according to claim 11 wherein the side walls are stepped in profile such that a shoulder is formed at each of the mating positions.

15. The combination according to claim 14 wherein the mating portion includes a longitudinally extending portion of constant cross sectional dimension at each mating position.

16. A fastener socket arranged for use with a plurality of Robertson type screwdriver bits different in size from one another, the socket comprising:
four side walls having identical dimensions and being arranged such that the walls have a square cross section substantially throughout a length thereof between an inner bottom end and an outer free end of the socket;
the side walls tapering inwardly towards one another from the outer free end to the inner bottom end such that the side walls are arranged to mate with each of the plurality of Robertson type screwdriver bits different in size from one another at respective mating positions along the side walls.

17. The socket according to claim 16 wherein the side walls are continuous in profile such that the socket has a gradually decreasing cross sectional dimension from the outer free end to the inner bottom end.

18. The socket according to claim 17 wherein the side walls are concave.

19. The socket according to claim 16 wherein the side walls are stepped in profile defining a shoulder at each of the mounting positions.

20. The socket according to claim 19 wherein there is provided a longitudinally extending portion of constant cross sectional dimension at each mating position along the side walls of the socket.
